(19) United States
(12) Patent Application Publication
(10) Pub. No.: US 2024/0109927 A1
(43) Pub. Date: Apr. 4, 2024

(54) BIS (ARENE) METAL COMPLEXES AND RELATED METHODS

(71) Applicant: ENTEGRIS, INC., Billerica, MA (US)

(72) Inventor: David Kuiper, Brookfield, CT (US)

(21) Appl. No.: 18/240,151

(22) Filed: Aug. 30, 2023

Related U.S. Application Data
(60) Provisional application No. 63/404,825, filed on Sep. 8, 2022.

(51) Int. Cl. C07F 17/00

(52) U.S. Cl. CPC C07F 17/00

(57) ABSTRACT

Methods relating to the preparation and purification of bis (arene) metal complexes are provided. A method may comprise contacting a metal halide, with a first metal component and an aluminum halide, in a first solvent, so as to form a reaction mixture comprising an intermediate complex. A method may comprise contacting the intermediate complex, with a second metal component, in a reaction mixture comprising a second solvent, so as to form a reaction mixture comprising a bis (arene) metal complex. A method may comprise contacting the reaction mixture comprising the bis (arene) metal complex, with a separation media, so as to obtain a product. Bis (arene) metal complexes are also provided.

### FIELD

The present disclosure relates to the synthesis and purification of bis (arene) metal complexes, as well as related compositions and methods.

### BACKGROUND

The synthesis and purification of organometallic compounds is presented with numerous challenges. Organometallic compounds are often produced in reaction mixtures containing mixed ligand complexes. Due to similar molecular weights, these organometallic compounds cannot be easily separated and purified. Organometallic compounds are also often produced in low yields. This presents issues with scaling up processes for commercial production.

### SUMMARY

Some embodiments of the present disclosure relate to a method. In some embodiments, the method comprises one or more of the following: contacting a metal halide, with a first metal component and an aluminum halide, in a first solvent, so as to form a reaction mixture comprising an intermediate complex; contacting the intermediate complex, with a second metal component, in a reaction mixture comprising a second solvent, so as to form a reaction mixture comprising a bis (arene) metal complex; and obtaining a product.

Some embodiments of the present disclosure relate to a method. In some embodiments, the method comprises one or more of the following: contacting a metal halide, with a first metal component and an aluminum halide, in a first solvent, so as to form a reaction mixture comprising an intermediate complex; contacting the intermediate complex, with a second metal component, in a reaction mixture comprising a second solvent, so as to form a reaction mixture comprising a bis (arene) metal complex; and contacting the reaction mixture comprising the bis (arene) metal complex, with a separation media, so as to obtain a product. In some embodiments, the product comprises a purified bis (arene) metal complex and less than 10% impurities.

Some embodiments of the present disclosure relate to a method. In some embodiments, the method comprises one or more of the following steps: contacting a metal halide, with a first metal component and an aluminum halide, in a first solvent, so as to form a reaction comprising an intermediate complex; and contacting the intermediate complex, with a second metal component, in a reaction mixture comprising a second solvent, so as to form a reaction mixture comprising a bis (arene) metal complex.

In some embodiments of the present disclosure relates to a method. In some embodiments, the method comprises one or more of the following: contacting a metal halide, with a first metal component and an aluminum halide, in a first solvent, so as to form a reaction mixture comprising an intermediate complex; contacting the intermediate complex, with a second metal component, in a reaction mixture comprising a second solvent, so as to form a reaction mixture comprising a bis (arene) metal complex; performing a post synthesis aqueous extraction to purify the reaction mixture and obtain product.

Some embodiments of the present disclosure relate to a method. In some embodiments, the method comprises one or more of the following steps: obtaining a reaction mixture comprising a bis (arene) metal complex and at least one impurity; and contacting the reaction mixture comprising the bis (arene) metal complex, with a separation media, so as to obtain a product. In some embodiments, the product comprises a purified bis (arene) metal complex. In some embodiments, the product comprises less of the at least one impurity on a weight basis than the reaction mixture comprising the bis (arene) metal complex.

Some embodiments of the present disclosure relate to a composition that comprises a bis (arene) metal complex of the following formula:

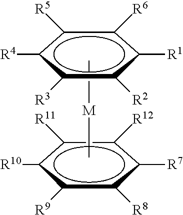

where: M is Mo, Wo, or Cr; R¹, R², R³, R⁴, R⁵, and R⁶ are each independently a hydrogen, an alkyl, an alkenyl, an alkynyl, a cycloalkyl, or an aryl; wherein two of R¹, R², R³, R⁴, R⁵, and R⁶ are optionally bonded to form a 6-membered aryl; R⁷, R⁸, R⁹, R¹⁰, R¹¹, and R¹² are each independently a hydrogen, an alkyl, an alkenyl, an alkynyl, a cycloalkyl, or an aryl; wherein two of R⁷, R⁸, R⁹, R¹⁰, R¹¹, and R¹² are optionally bonded to form a 6-membered aryl.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a flowchart of a non-limiting embodiment of a method, according to some embodiments.

FIG. 2 depicts a flowchart of a non-limiting embodiment of a method, according to some embodiments.

FIG. 3 depicts a schematic diagram of a non-limiting embodiment of a reaction scheme, according to some embodiments.

FIGS. 4A-4B depict ¹H NMR spectra (FIG. 3A) after and (FIG. 3B) before passing a solution through a column containing neutral alumina, according to some embodiments.

FIGS. 5A-5B depict ²⁷Al NMR spectra (FIG. 4A) after and (FIG. 4B) before passing a solution through a column containing neutral alumina, according to some embodiments.

FIGS. 6A-6C show a stacked ¹H NMR spectra of crude products, according to some embodiments.

FIGS. 7A-7B show ¹H NMR of crude product after aluminum reduction and after sequential magnesium reduction, according to some embodiments.

FIGS. 8A-8B show ²⁷Al NMR of crude product after aluminum reduction and after sequential magnesium reduction, according to some embodiments.

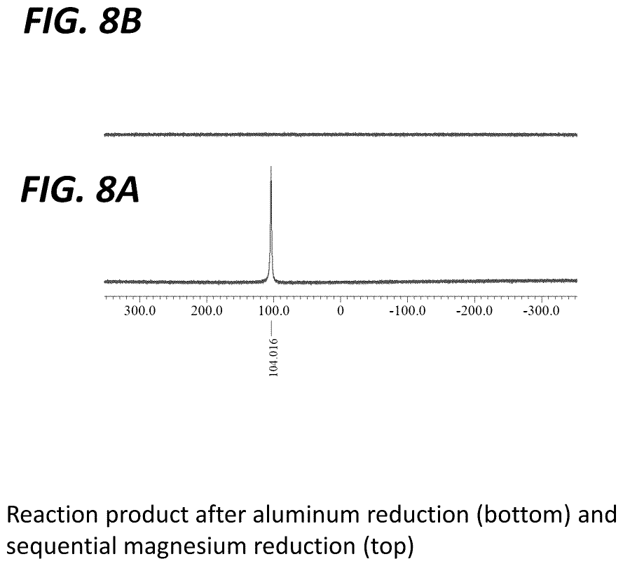

FIG. 9 depicts a schematic diagram of a non-limiting embodiment of a reaction scheme, according to some embodiments.

FIG. 10 shows Thermogravimetric Analysis (“TGA”) of product following post synthesis aqueous extraction, according to some embodiments.

FIG. 11 shows TGA of post synthesis aqueous extraction, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “alkyl” refers to a hydrocarbon chain radical having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl may comprise, consist of, or consist essentially of, or may be selected from the group consisting of, at least one of a C₁-C₁₂ alkyl, a C₁-C₁₁ alkyl, a C₁-C₁₀ alkyl, a C₁-C₉ alkyl, a C₁-C₈ alkyl, a C₁-C₇ alkyl, a C₁-C₆ alkyl, a C₁-C₄ alkyl, a C₁-C₃ alkyl, or any combination thereof. In some embodiments, the alkyl may comprise, consist of, or consist essentially of, or may be selected from the group consisting of, at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, octyl, decyl, dodecyl, octadecyl, or any combination thereof.

As used herein, the term “alkenyl” refers to a hydrocarbon chain radical having from 1 to 10 carbon atoms and at least one carbon-carbon double bond. Examples of alkenyl groups include, without limitation, at least one of vinyl, allyl, 1-methylvinyl, 1-propenyl, 1-butenyl, 2-butenyl, 3-butenyl, 1,3-butadienyl, 2-methyl-1-propenyl, 2-methyl-2-propenyl, 1-pentenyl, 2-pentenyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 3-heptenyl, 1-octenyl, 1,3-octadienyl, 1-nonenyl, 2-nonenyl, 3-nonenyl, 1-decenyl, 3-decenyl, 1-undecenyl, oleyl, linoleyl, linolenyl, or any combination thereof.

As used herein, the term “alkynyl” refers to a hydrocarbon chain radical having from 1 to 10 carbon atoms and at least one carbon-carbon triple bond. Examples of alkynyl groups include, without limitation, at least one of ethynyl, propynyl, n-butynyl, n-pentynyl, 3-methyl-1-butynyl, n-hexynyl, methyl-pentynyl, or any combination thereof.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. For example, two or more cycloalkyls may be fused, bridged, or fused and bridged to obtain the polycyclic non-aromatic carbocyclic ring. In some embodiments, the cycloalkyl comprises, consists of, or consists essentially of, or is selected from the group consisting of, at least one of cyclopropyl, cyclobutyl, cyclopentyl, cyclohexyl, cycloheptyl, cyclooctyl, or any combination thereof.

As used herein, the term “arene” refers to a monocyclic or polycyclic aromatic hydrocarbon compound comprising carbon and hydrogen atoms. In some embodiments, the arene has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an arene having a single aromatic ring structure. The term “polycyclic,” when used as a modifier, refers to an arene having more than one aromatic ring structure, which may be fused, bridged, spiro, or otherwise bonded ring structures. In some embodiments, the terms arene and aryl are used interchangeably.

Non-limiting examples of arenes include, without limitation, at least one of benzene, toluene, xylene (e.g., o-xylene, m-xylene, p-xylene), t-butyltoluene (e.g., o-t-butyltoluene, m-t-butyltoluene, p-t-butyltoluene), ethylmethylbenzene (e.g., 1-ethyl-4-methylbenzene, 1-ethyl-3-methylbenzene), 1-isopropyl-4-methylbenzene, 1-t-butyl-4-methylbenzene, mesitylene, pseudocumene, durene, methylbenzene, dimethylbenzene, trimethylbenzene, ethylbenzene, diethylbenzene (e.g., 1,4-diethylbenzene), triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof, and the like.

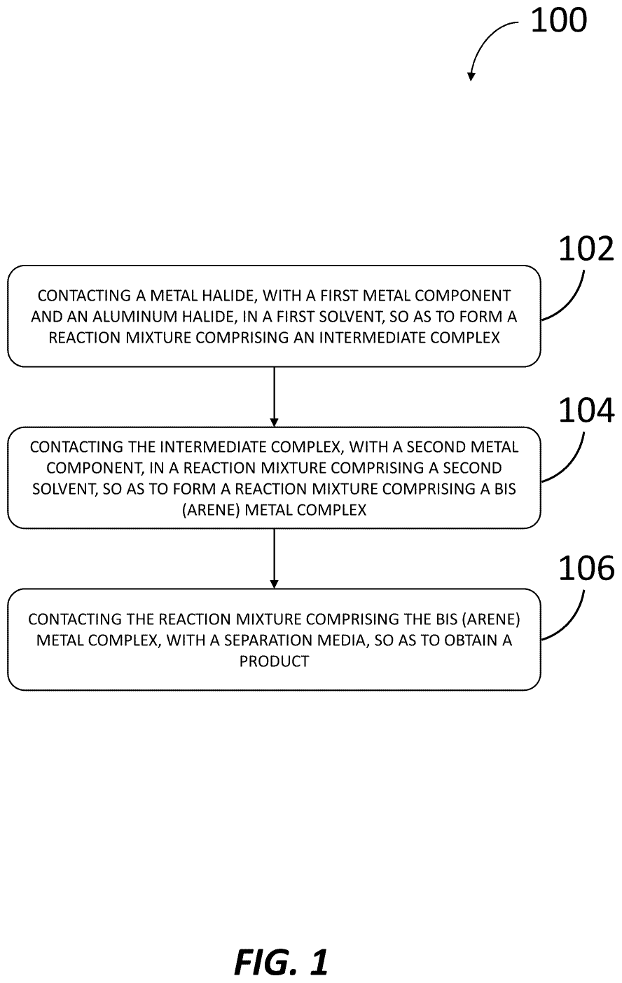

FIG. 1 is a flowchart of a method 100 of making a bis (arene) metal complex, according to some embodiments. As shown in FIG. 1, the method of making a bis (arene) metal complex comprises one or more of the following: wherein 102 includes contacting a metal halide, with a first metal component and an aluminum halide, in a first solvent, so as to form a reaction mixture comprising an intermediate complex; 104 of contacting the intermediate complex with a second metal component in a reaction mixture comprising a second solvent, so as to form a reaction mixture comprising a bis (arene) metal complex; and 106 of contacting the reaction mixture comprising the bis (arene) metal complex, with a separation media, so as to obtain a product, the product comprising a purified bis (arene) metal complex and less than 10% impurities. It will be appreciated that the method 100 includes any combination of at least two of the step 102, the step 104, the step 106, or any combination thereof.

At step 102, in some embodiments, the method 100 of making the bis (arene) metal complex comprises contacting a metal halide, with a first metal component and an aluminum halide, in a first solvent, so as to form a reaction mixture comprising an intermediate complex.

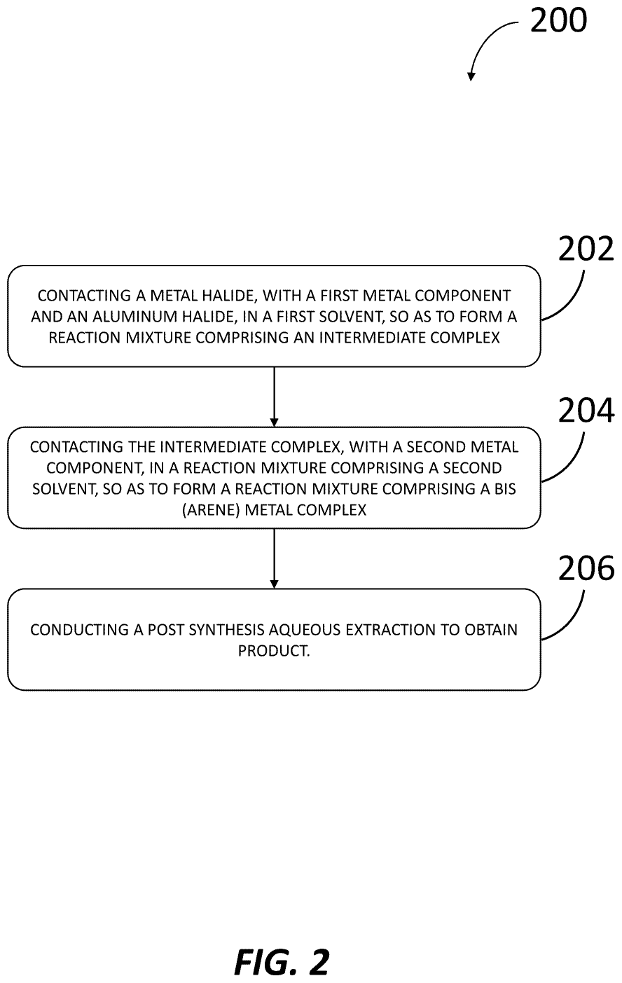

In an another embodiment of the present disclosure, the method used to make bis (arene) metal complex is referred to in FIG. 2. As shown in FIG. 2, the method of making a bis (arene) metal complex comprises one or more of the following: wherein 202 includes contacting a metal halide, with a first metal component and an aluminum halide, in a first solvent, so as to form a reaction mixture comprising an intermediate complex; 204 of contacting the intermediate complex with a second metal component in a reaction mixture comprising a second solvent, so as to form a reaction mixture comprising a bis (arene) metal complex; and 206 of conducting a post synthesis aqueous extraction in order to obtain a product, the product comprising a purified bis (arene) metal complex and less than 10% impurities. It will be appreciated that the method 200 includes any combination of at least two of the step 202, the step 204, the step 206, or any combination thereof.

Referring to the method in FIG. 1 and FIG. 2, the metal halide may be contacted at a first temperature. In some embodiments, the first temperature is a boiling point of the first solvent. In some embodiments, the first temperature is a temperature in a range of 50° C. to 200° C. For example, in some embodiments, the first temperature is a temperature in a range of 50° C. to 190° C., 50° C. to 180° C., 50° C. to 170° C., 50° C. to 160° C., 50° C. to 150° C., 50° C. to 140° C., 50° C. to 130° C., 50° C. to 120° C., 50° C. to 110° C., 50° C. to 100° C., 50° C. to 90° C., 50° C. to 80° C., 50° C. to 70° C., 60° C. to 200° C., 70° C. to 200° C., 80° C. to 200° C., 90° C. to 200° C., 100° C. to 200° C., 110° C. to 200° C., 120° C. to 200° C., 130° C. to 200° C., 140° C. to 200° C., 150° C. to 200° C., 160° C. to 200° C., 170° C. to 200° C., 180° C. to 200° C., or any range or subrange therebetween. In some embodiments, the first temperature is no greater than a decomposition temperature of at least one of the metal halide, the first metal component, the aluminum halide, the first solvent, the intermediate complex, or any combination thereof.

The contacting may comprise at least one of, directly or indirectly, reducing, reacting, introducing, heating, or any combination thereof. In some embodiments, the contacting comprises contacting at least one of the metal halide, the first metal component, the aluminum halide, the first solvent, or any combination thereof. In some embodiments, the contacting comprises reacting at least one of the metal halide, the first metal component, the aluminum halide, the first solvent, or any combination thereof. In some embodiments, the contacting comprises heating at least one of the metal halide, the first metal component, the aluminum halide, the first solvent, or any combination thereof. In some embodiments, the contacting comprises reducing at least one of the metal halide, the first metal component, the aluminum halide, the first solvent, or any combination thereof.

The metal halide may comprise at least one of molybdenum (Mo), chromium (Cr), tungsten (W), or any combination thereof. In some embodiments, the metal halide comprises at least one of MoCl₂, MoCl₃, MoCl₄, MoCl₅, MoCl₆, or any combination thereof. In some embodiments, the metal halide comprises at least one of CrCl₂, CrCl₃, or any combination thereof. In some embodiments, the metal halide comprises at least one of WCl₂, WCl₃, WCl₄, WCl₅, WCl₆, or any combination thereof. In some embodiments, the metal halide comprises at least one of MoCl₂, MoCl₃, MoCl₄, MoCl₅, MoCl₆, CrCl₂, CrCl₃, WCl₂, WCl₃, WCl₄, WCl₅, WCl₆, or any combination thereof. In some embodiments, the metal halide comprises at least one of WCl₂, WCl₃, WCl₄, WCl₅, WCl₆, WBr₂, WBr₃, WBr₄, WBr₅, WBr₆, WI₂, WI₃, WI₄, WI₅, WI₆, MoCl₂, MoCl₃, MoCl₄, MoCl₅, MoBr₂, MoBr₃, MoBr₄, MoBr₅, MoI₂, MoI₃, MoI₄, MoI₅, or any combination thereof. In some embodiments, the metal halide comprises a transition metal. In some embodiments, for example, the metal halide comprises at least one of Sc, Y, Ti, Zr, Hf, V, Nb, Ta, Cr, Mo, W, Mn, Tc, Re, Fe, Ru, Os, or any combination thereof.

The first metal component may comprise a metal in a solid form. For example, in some embodiments, the first metal component may comprise a metal in a form of a powder, a particle, or a tablet. In some embodiments, the metal of the first metal component comprises at least one of Li, Na, K, Rb, Cs, Mg, Ca, Cd, Sr, Ba, Al, Ga, In, Zn, Sn, Fe, Ni, any alloy thereof, or any combination thereof. For example, in some embodiments, the first metal component comprises at least one of Al, Ga, In, Zn, Sn, any alloy thereof, or any combination thereof. In some embodiments, the first metal component comprises at least one of an aluminum powder, a magnesium powder, a zinc powder, or any combination thereof. In some embodiments, the first metal component comprises an alloy. For example, in some embodiments, the first metal component comprises an aluminum magnesium alloy powder. In some embodiments, the first metal component comprises at least one of an iron powder, a nickel powder, or any combination thereof.

The first metal component may have an average particle size. The average particle size may refer to an average particle size of at least 50% of the first metal component. In some embodiments, the first metal component has an average particle size in a range of 50 nm to 100 μm. For example, in some embodiments, the first metal component has an average particle size in a range of 20 μm to 100 μm, 1 μm to 5 μm, 50 nm to 900 nm, or any combination thereof, or any range or subrange therebetween.

The aluminum halide may comprise at least one of aluminum chloride, aluminum bromide, aluminum iodide, or any combination thereof. Examples of aluminum chloride include, without limitation, at least one of AlCl₂, AlCl₃, hydrated forms thereof, of any combination thereof. Examples of aluminum bromide include, without limitation, at least one of AlBr₂, AlBr₃, hydrated forms thereof, of any combination thereof. Examples of aluminum iodide include, without limitation, at least one of AlI₂, AlI₃, hydrated forms thereof, or any combination thereof.

The first solvent may comprise an arene. For example, the first solvent may comprise an aromatic solvent. In some embodiments, the first solvent comprises a compound of the formula:

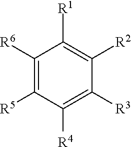

where:
R¹, R², R³, R⁴, R⁵, and R⁶ are each independently a hydrogen, an alkyl, an alkenyl, an alkynyl, a cycloalkyl, or an aryl; or
wherein two of R¹, R², R³, R⁴, R⁵, and R⁶ are optionally bonded to form a 6-membered aryl.

In some embodiments, the first solvent comprises a compound of the formula:

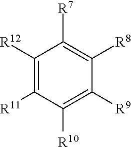

where:
R⁷, R⁸, R⁹, R¹⁰, R¹¹, and R¹² are each independently a hydrogen, an alkyl, an alkenyl, an alkynyl, a cycloalkyl, or an aryl;
wherein two of R⁷, R⁸, R⁹, R¹⁰, R¹¹, and R¹² are optionally bonded to form a 6-membered aryl.

In some embodiments, the first solvent does not comprise a heteroatom. In some embodiments, the first solvent does not comprise a halide.

In some embodiments, the first solvent comprises at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof. In some embodiments, the first solvent comprises an alkyl-substituted benzene. In some embodiments, the first solvent comprises an aryl-substituted benzene. In some embodiments, the first solvent does not comprise a heteroatom (e.g., as a ring atom of the arene). In some embodiments, the first solvent does not comprise a halide substituent on the arene.

The resulting reaction mixture comprises the intermediate complex. In some embodiments, the intermediate complex is a complex of the formula: [bis (first solvent) metal]⁺[aluminum halide]⁻. In some embodiments, the metal is molybdenum (Mo), chromium (Cr), or tungsten (W). In some embodiments, the halide is chloride (CI), bromide (Br), or iodide (I). In some embodiments, the intermediate complex comprises [bis (toluene) molybdenum]⁺[AlCl₄]⁻.

Referring to FIG. 1, at step 104, in some embodiments, the method 100 of making the bis (arene) metal complex comprises contacting the intermediate complex with a second metal component in a reaction mixture comprising a second solvent, so as to form a reaction mixture comprising a bis (arene) metal complex.

The contacting may comprise at least one of, indirectly or directly, reducing, reacting, heating, introducing, or any combination thereof. In some embodiments, the contacting comprises contacting at least one of the intermediate complex, the second metal component, the second solvent, the reaction mixture comprising the second solvent, or any combination thereof. In some embodiments, the contacting comprises reacting at least one of the intermediate complex, the second metal component, the second solvent, the reaction mixture comprising the second solvent, or any combination thereof. In some embodiments, the contacting comprises heating at least one of the intermediate complex, the second metal component, the second solvent, the reaction mixture comprising the second solvent, or any combination thereof. In some embodiments, the contacting comprises reducing at least one of the intermediate complex, the second metal component, the second solvent, the reaction mixture comprising the second solvent, or any combination thereof.

The contacting may proceed at a second temperature. In some embodiments, the contacting comprises reducing the intermediate complex at the second temperature. In some embodiments, the second temperature is a temperature in a range of 0° C. to 150° C. In some embodiments, the second temperature is a temperature in a range of 10° C. to 150° C., 20° C. to 150° C., 30° C. to 150° C., 40° C. to 150° C., 50° C. to 150° C., 60° C. to 150° C., 70° C. to 150° C., 80° C. to 150° C., 90° C. to 150° C., 100° C. to 150° C., 110° C. to 150° C., 120° C. to 150° C., 130° C. to 150° C., 140° C. to 150° C., 0° C. to 10° C., 0° C. to 20° C., 0° C. to 30° C., 0° C. to 40° C., 0° C. to 50° C., 0° C. to 60° C., 0° C. to 70° C., 0° C. to 80° C., 0° C. to 90° C., 0° C. to 100° C., 0° C. to 110° C., 0° C. to 120° C., 0° C. to 130° C., 0° C. to 140° C., or any range or subrange between 0° C. to 150° C.

The second metal component may comprise a metal in a solid form. For example, in some embodiments, the second metal component may comprise a metal in a form of a powder, a particle, or a tablet. In some embodiments, the metal of the first metal component comprises at least one of Li, Na, K, Rb, Cs, Mg, Ca, Cd, Sr, Ba, Al, Ga, In, Zn, Sn, Fe, Ni, any alloy thereof, or any combination thereof. For example, in some embodiments, the first metal component comprises at least one of Al, Ga, In, Zn, Sn, any alloy thereof, or any combination thereof. In some embodiments, the second metal component comprises at least one of an aluminum powder, a magnesium powder, a zinc powder, or any combination thereof. In some embodiments, the second metal component comprises an alloy. For example, in some embodiments, the second metal component comprises an aluminum magnesium alloy powder. In some embodiments, the second metal component comprises at least one of an iron powder, a nickel powder, or any combination thereof. In some embodiments, the second metal component is same as the first metal component. In some embodiments, the second metal component is different from the first metal component.

The second metal component may have an average particle size. The average particle size may refer to an average particle size of at least 50% of the second metal component. In some embodiments, the second metal component has an average particle size in a range of 50 nm to 100 μm. For example, in some embodiments, the second metal component has an average particle size in a range of 20 μm to 100 μm, 1 μm to 5 μm, 50 nm to 900 nm, or any combination thereof, or any range or subrange therebetween.

The second solvent may comprise an ethereal solvent. In some embodiments, the second solvent comprises a reducing solvent. In some embodiments, the second solvent comprises a solvent having a boiling point sufficient to permit removal of the solvent, under vacuum, at temperatures less than a sublimination temperature of the bis (arene) metal complex. For example, in some embodiments, the solvent has a boiling point of less than 150° C., less than 140° C., less than 130° C., less than 120° C., or less than 110° C. In some embodiments, the second solvent comprises a solvent having an ether linkage. In some embodiments, the second solvent comprises at least one of tetrahydrofuran, methyl tetrahydrofuran, dimethoxyethane (DME), triglyme, diethylether, diisopropylether, dibutyl ether, cyclopentylmethyl ether, methyl tert-butyl ether (MTBE), or any combination thereof. In some embodiments, the second solvent comprises 80/20 mixture of dimethoxyethane (DME) and tetrahydrofuran (THF). In some embodiments, the second solvent may comprise a solvent for dissolving the bis (arene) metal complex. In some embodiments, for example, the second solvent comprises at least one of toluene, hexane, or any combination thereof.

The resulting reaction mixture may comprise the bis (arene) metal complex. In some embodiments, the bis (arene) metal complex is a bis (first solvent) metal complex. In some embodiments, the bis (arene) metal complex comprises a compound of the formula:

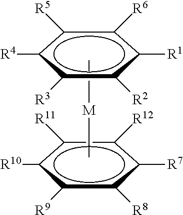

where:
M is Mo, Wo, or Cr;
R¹, R², R³, R⁴, R⁵, and R⁶ are each independently a hydrogen, an alkyl, an alkenyl, an alkynyl, a cycloalkyl, or an aryl;
wherein two of R¹, R², R³, R⁴, R⁵, and R⁶ are optionally bonded to form a 6-membered aryl;
R⁷, R⁸, R⁹, R¹⁰, R¹¹, and R¹² are each independently a hydrogen, an alkyl, an alkenyl, an alkynyl, a cycloalkyl, or an aryl;
wherein two of R⁷, R⁸, R⁹, R¹⁰, R¹¹, and R¹² are optionally bonded to form a 6-membered aryl.

In some embodiments, the bis (arene) metal complex comprises at least one of a bis (benzene) metal complex, a bis (toluene) metal complex, a bis (xylene) metal complex, a bis (butyltoluene) metal complex, a bis (ethyl methyl benzene) metal complex, a bis (ethyl methylbenzene) metal complex, a bis (isopropyl methyl benzene) metal complex, a bis (butyl methylbenzene) metal complex, a bis (mesitylene) metal complex, a bis (pseudocumene) metal complex, a bis (durene) metal complex, a bis (methylbenzene) metal complex, a bis (dimethylbenzene) metal complex, a bis (trimethylbenzene) metal complex, a bis (ethylbenzene) metal complex, a bis (1,4-diethylbenzene) metal complex, a bis (triethylbenzene) metal complex, a bis (propylbenzene) metal complex, a bis (butylbenzene) metal complex, a bis (iso-butylbenzene) metal complex, a bis (sec-butylbenzene) metal complex, a bis (t-butylbenzene) metal complex, a bis (hexylbenzene) metal complex, a bis (styrene) metal complex, a bis (naphthalene) metal complex, a bis (anthracene) metal complex, a bis (phenanthrene) metal complex, a bis (biphenyl) metal complex, a bis (terphenyl) metal complex, a bis (methylnaphthalene) metal complex, a bis (biphenylene) metal complex, a bis (dimethylnaphthalene) metal complex, a bis (methylanthracene) metal complex, a bis (4,4′-dimethylbiphenyl) metal complex, a bis (bibenzyl) metal complex, a bis (diphenylmethane) metal complex, any isomer thereof, or any combination thereof.

In some embodiments, the reaction mixture comprising the bis (arene) metal complex comprises no more than 50% by weight of at least one impurity based on a total weight of the reaction mixture comprising the bis (arene) metal complex. In some embodiments, the reaction mixture comprising the bis (arene) metal complex, comprises 0.01% to 50%, 0.01% to 45%, 0.01% to 40%, 0.01% to 35%, 0.01% to 30%, 0.01% to 25%, 0.01% to 20%, 0.01% to 15%, 0.01% to 10%, 5% to 50%, 10% to 50%, 15% to 50%, 20% to 50%, 25% to 50%, 30% to 50%, 35% to 50%, 40% to 45%, or 45% to 50% by weight of the at least one impurity based on the total weight of the reaction mixture comprising the bis (arene) metal complex. In some embodiments, the impurities comprise at least one of aluminum halide impurities, coupled aromatic impurities, polyaromatic impurities, or any combination thereof. In some embodiments, the impurities comprise at least one of an aluminum halide, a tetrahydrofuran coordinated to an aluminum halide, a coupled arene compound (e.g., a dimethylbiphenyl compound), or any combination thereof. In some embodiments, the coupled arene compound comprises a compound of the formula:

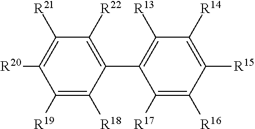

where: R¹³, R¹⁴, R¹⁵, R¹⁶, R¹⁷, R¹⁸, R¹⁹, R²⁰, R²¹, and R²² are each independently a hydrogen, an alkyl, an alkenyl, an alkynyl, a cycloalkyl, or an aryl.

In some embodiments, the reaction mixture comprising the bis (arene) metal complex does not comprise a compound of the formula: [MXₐ (second solvent)_{b}]⁺[MX_{c}]⁻, where: M is a metal (e.g., aluminum), X is a halide (e.g., CI, Br, I, or F), a is 1 to 10, b is 1 to 10, c is 1 to 10. In some embodiments, the reaction mixture comprising the bis (arene) metal complex does not comprise [AlCl₂(THF)₄]⁺[AlCl₄]⁻. In some embodiments, the reaction mixture comprising the bis (arene) metal complex does not comprise a detectable level of [AlCl₂(THF)₄]⁺[AlCl₄]⁻.

Referring to FIG. 1, in step 106, in some embodiments, the method 100 of making the bis (arene) metal complex comprises contacting the reaction mixture comprising the bis (arene) metal complex, with a separation media, so as to obtain a product. In some embodiments, the product comprises a purified bis (arene) metal complex and optionally at least one impurity.

The reaction mixture comprising the bis (arene) metal complex, may be contacted with the separation media. The contacting may include flowing the reaction mixture comprising the bis (arene) metal complex, through a column containing the separation media sufficient for the separation media to remove at least a portion of the impurities present in the reaction mixture comprising the bis (arene) metal complex. In some embodiments, prior to the contacting, the method further comprises at least one of the following steps: filtering the reaction mixture comprising the bis (arene) metal complex, so as to obtain a filtered reaction mixture; drying the reaction mixture comprising the bis (arene) metal complex, so as to obtain a dried reaction mixture; contacting the reaction mixture comprising the bis (arene) metal complex, with an extracting solvent so as to obtain an extracted reaction mixture; filtering an extract organic phase from the extracted reaction mixture; or any combination thereof. In some embodiments, the extracting solvent is an aliphatic solvent. For example, in some embodiments, the aliphatic solvent comprises at least one of hexane, pentane, or any combination thereof.

The separation media may be useful for separating (e.g., sorbing, adsorbing, absorbing, etc.) the at least one impurity from the reaction mixture comprising the bis (arene) metal complex. In some embodiments, the separation media comprises at least one of neutral alumina, acidic alumina, basic alumina, florisil, silica, or any combination thereof. In some embodiments, the separation media comprises magnesium silicate. In some embodiments, the magnesium silicate is a compound of formula MgO:XSiO₂, where X is 1 to 10. In some embodiments, the magnesium silicate is hydrated and is a compound of the formula MgO:XSiO₂·H₂O, where X is 1 to 10.

The separation media may have an average particle size. The average particle size may refer to an average particle size of at least 50% of the separation media. In some embodiments, the separation media has an average particle size of 25 microns to 250 microns. In some embodiments, the separation media has an average particle size of 25 micron to 225 micron, 25 micron to 200 micron, 25 micron to 175 micron, 25 micron to 150 micron, 25 micron to 125 micron, 25 micron to 100 micron, 25 micron to 75 micron, 25 micron to 50 micron, 50 micron to 250 micron, 75 micron to 250 micron, 100 micron to 250 micron, 125 micron to 250 micron, 150 micron to 250 micron, 175 micron to 250 micron, 200 micron to 250 micron, 225 micron to 250 micron, or any range or subrange therebetween.

Referring to FIG. 2, in some embodiments of the present disclosure the reaction mixture comprising the bis (arene) metal complex may undergo a post synthesis aqueous extraction in order to obtain the resulting purified product.

In certain embodiments of the present disclosure, the post synthesis aqueous extraction includes methods known in relevant art. By example, one method of post aqueous extraction includes drying the reaction mixture comprising the bis (arene) metal complex from step 204, so as to obtain a dried reaction mixture; this may be partially drying the reaction mixture comprising the bis (arene) metal complex so as to obtain a partially dried reaction mixture; contacting the dried or partially dried reaction mixture comprising the bis (arene) metal complex with an extracting solvent so as to obtain an extracted reaction mixture; filtering an extracted organic phase from the extracted reaction mixture to obtain an organic extracted reaction filtrate; cooling the organic extracted reaction filtrate to a temperature in the range of −30 to 20° C.; contacting the organic extracted reaction filtrate with water so as to obtain an aqueous extracted reaction mixture; filtering an aqueous extracted reaction mixture so as to obtain a purified organic reaction filtrate; drying a purified organic reaction filtrate so as to obtain a purified product; or any combination thereof.

In some embodiments of the present disclosure the organic extracted reaction mixture may be cooled to a range of −15 to 15° C., in other embodiments it can be −10 to 10° C. and any variations in between,

In some embodiments of the present disclosure, the extracting solvent can be an aromatic solvent. For example, in some embodiments, the aromatic solvent comprises at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, or any combination thereof.

In some embodiments of the present disclosure, the extracting solvent can be an aliphatic solvent. For example, in some embodiments, the aliphatic solvent comprises at least one of hexane, pentane, heptane, octane, cyclohexane, methylcyclohexane, or any combination thereof.

In some embodiments of the present invention, after step 204 in FIG. 2, the reaction mixture can be further purified by using a separation media as described in this disclosure.

The product in embodiments described in this present disclosure, may comprise the purified bis (arene) metal complex and less of the at least one impurity on a weight basis than the reaction mixture comprising the bis (arene) metal complex (e.g., which was contacted with the separation media). The product may comprise no more than 10% impurities. In some embodiments, for example, the product comprises no more than 9% impurities, no more than 8% impurities, no more than 7% impurities, no more than 6% impurities, no more than 5% impurities, no more than 4% impurities, no more than 3% impurities, no more than 2% impurities, no more than 1.9% impurities, no more than 1.8% impurities, no more than 1.7% impurities, no more than 1.6% impurities, no more than 1.5% impurities, no more than 1.4% impurities, no more than 1.3% impurities, no more than 1.2% impurities, no more than 1.1% impurities, no more than 1% impurities, no more than 0.9% impurities, no more than 0.8% impurities, no more than 0.7% impurities, no more than 0.6% impurities, no more than 0.5% impurities, no more than 0.4% impurities, no more than 0.3% impurities, no more than 0.2% impurities, or no more than 0.1% impurities.

In some embodiments, the product comprises 0.01% to 10% impurities, 0.1% to 2% impurities, 0.1% to 1.9% impurities, 0.1% to 1.8% impurities, 0.1% to 1.7% impurities, 0.1% to 1.6% impurities, 0.1% to 1.5% impurities, 0.1% to 1.4% impurities, 0.1% to 1.3% impurities, 0.1% to 1.2% impurities, 0.1% to 1% impurities, 0.1% to 0.9% impurities, 0.1% to 0.8% impurities, 0.1% to 0.7% impurities, 0.1% to 0.6% impurities, 0.1% to 0.5% impurities, 0.1% to 0.4% impurities, 0.1% to 0.3% impurities, 0.2% to 2% impurities, 0.3% to 2% impurities, 0.4% to 2% impurities, 0.5% to 2% impurities, 0.6% to 2% impurities, 0.7% to 2% impurities, 0.8% to 2% impurities, 0.9% to 2% impurities, 1% to 2% impurities, 1.1% to 2% impurities, 1.2% to 2% impurities, 1.3% to 2% impurities, 1.4% to 2% impurities, 1.5% to 2% impurities, 1.6% to 2% impurities, 1.7% to 2% impurities, or 1.8% to 2% impurities. In some embodiments, the product comprises an undetectable level of an aluminum halide as determined by ²⁷Al NMR spectroscopy.

In some embodiments, the impurities comprise at least one of, but not limited to, magnesium halide impurities, aryl magnesium halide impurities, aryl magnesium halide impurities coordinated by an ethereal solvent, anionic aryl molybdenum “ate” complexes, aluminum halide impurities, coupled aromatic impurities, polyaromatic impurities, or any combination thereof. In some embodiments, the impurities comprise at least one of an aluminum halide, a tetrahydrofuran coordinated to an aluminum halide, a coupled arene compound (e.g., a dimethylbiphenyl compound), a methylene bridged diarene compound, or any combination thereof. In some embodiments, the coupled arene compound comprises a compound of the formula:

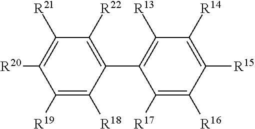

where: R¹³, R¹⁴, R¹⁵, R¹⁶, R¹⁷, R¹⁸, R¹⁹, R²⁰, R²¹, and R²² are each independently a hydrogen, an alkyl, an alkenyl, an alkynyl, a cycloalkyl, or an aryl.

In some embodiments the impurities comprise a compound of the formula

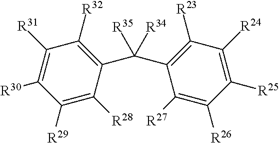

where: R²³, R²⁴, R²⁵, R²⁶, R²⁷, R²⁸, R²⁹, R³⁰, R³¹, R³², R³³, and R³⁴ are each independently a hydrogen, an alkyl, an alkenyl, an alkynyl, a cycloalkyl, or an aryl.

The presence and type of impurities, including quantity of impurities, may be measured using ¹H NMR spectroscopy, ²⁷Al NMR spectroscopy, or any combination thereof. In some embodiments, the product comprises an undetectable level of an aluminum halide as determined by ²⁷Al NMR spectroscopy.

### Example 1

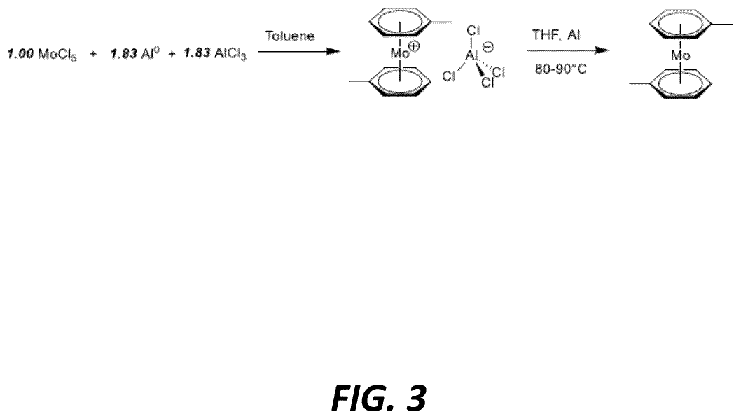

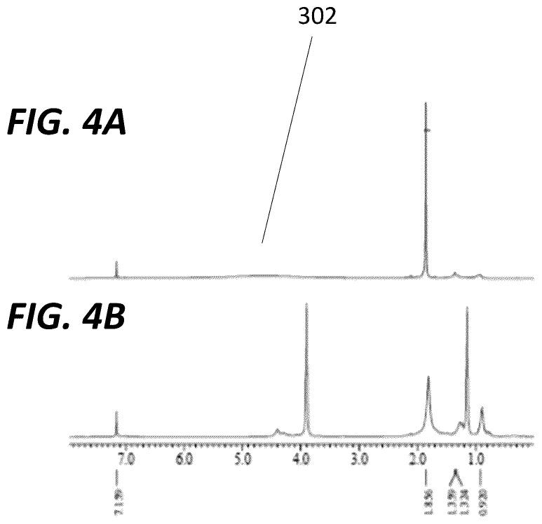

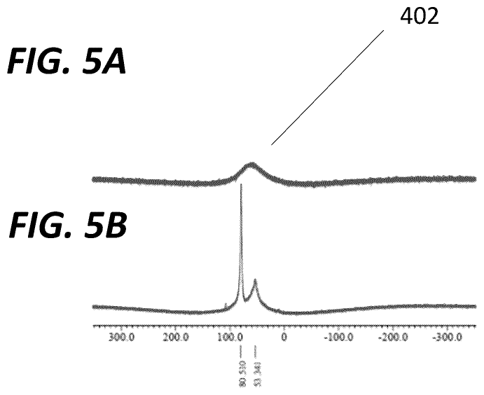

A two-necked round-bottom flask was charged with molybdenum pentachloride (MoCl₅), anhydrous aluminum trichloride (AlCl₃), and aluminum powder)(A°. Toluene was added and the mixture was stirred and heated to reflex in a hot bath at about 110° C. After 40 hours the mixture was cooled to about 40° C. and tetrahydrofuran was slowly added. The mixture was heated to reflux in a hot bath, which was heated to about 100° C., for about 15 hours, before being cooled to ambient and filtered to remove excess aluminum powder. The filtrate was washed with pentane and evaporated to dryness under vacuum (0.1 Pa). Thereafter, the residue was extracted with boiling pentane and the extract was filtered and concentrated. The solution containing the extract was passed through a column packed with neutral alumina to obtain a bis (toluene) molybdenum complex. A schematic diagram of the reaction scheme is presented in FIG. 3. FIGS. 4A-4B present ¹H NMR spectra (FIG. 4A) after and (FIG. 4B) before passing the solution through the column. In FIG. 4A, the broadening of aromatic resonances is shown via reference number 302. FIGS. 5A-5B presents ²⁷Al NMR spectra (FIG. 5A) after and (FIG. 5B) before passing the solution through the column. In FIG. 5A, the probe background peak is shown via reference number 402.

### Example 2

Bis(Toluene)Molybdenum Synthesis with Solvent and Reaction Time Varied. A 100 mL round bottom flask was equipped with a PTFE coated magnetic stir egg and charged with molybdenum pentachloride (3.00 g, 10.9 mmol, 1.00 eq), aluminum trichloride (1.66 g, 12.5 mmol, 1.15 eq), −325 mesh aluminum powder (0.439 g, 16.3 mmol, 1.50 eq), toluene (29.1 g, 316 mmol, 29 eq), and dodecane (18.5 g, 109 mmol, 10 eq). The mixture was stirred for 30 minutes to allow the initial exotherm (10° C. to 20° C.) to subside and was then refluxed in an oil bath at 135° C. for 40 hours resulting in the formation of a two-phase reaction mixture. The reaction mixture was allowed to cool, and the clear brownish supernatant was decanted. To the remaining dark oily lower phase containing the intermediate [(toluene)₂Mo][AlCl₄] was added toluene (29 g), magnesium powder (1.58 g, 65.3 mmol, 6.00 eq), and tetrahydrofuran (25.0 g) in a dropwise fashion over about 10 minutes. The deep green reaction mixture was heated to reflux for 18 hours, allowed to cool, and filtered through a medium porosity fritted funnel. The green-brown filtrates were stripped of solvent under reduced pressure (100 mtorr) and then extracted with a 100 mL aliquot and a 50 ml aliquot of boiling hexanes to give a green solution after filtration. The filtrates were concentrated under reduced pressure to give 3.90 g of a gummy green solid. The green solid was dissolved in a 50/50 mixture of toluene and hexanes and subsequently eluted through a 3 cm high, 4.5 cm diameter bed of neutral alumina, leaving behind a red-brown band on the alumina and resulting in an emerald green solution. The green product solution was concentrated to a green solid under reduced pressure resulting in 1.58 g (52%) of green product. The solid green product was then sublimed in an oil bath at 110° C. and at 300 mtorr to give 1.38 g (43%) of green crystalline product.

¹H NMR (400 MHz, d₆-benzene, 298K): δ 4.60 (br s, 5H), 1.86 (s, 3H) ppm. ¹³C {¹H} NMR (100 MHz, d₆-benzene, 289K): δ 89.71, 78.34, 76.08, 75.14, 21.76 ppm.

### Example 3

Bis(Toluene)Molybdenum Synthesis with Solvent and Reaction Time Varied. A 100 mL round bottom flask was equipped with a PTFE coated magnetic stir egg and charged with molybdenum pentachloride (3.00 g, 10.9 mmol, 1.00 eq), aluminum trichloride (1.66 g, 12.5 mmol, 1.15 eq), −325 mesh aluminum powder (0.439 g, 16.3 mmol, 1.50 eq), and toluene (29.1 g, 316 mmol, 29 eq). The mixture was stirred for 30 minutes to allow the initial exotherm (10° C. to 20° C.) to subside and was then refluxed in an oil bath at 135° C. for 40 hours resulting in the formation of a two-phase reaction mixture. The reaction mixture was allowed to cool and was treated with magnesium powder (1.58 g, 65.3 mmol, 6.00 eq) and tetrahydrofuran (25.0 g) in a dropwise fashion over about 10 minutes. The deep green reaction mixture was heated to reflux for 18 hours, allowed to cool, and filtered through a medium porosity fritted funnel. The green-brown filtrates were stripped of solvent under reduced pressure (100 mtorr) and then extracted with a 100 mL aliquot and a 50 ml aliquot of boiling hexanes to give a green solution after filtration. The filtrates were concentrated under reduced pressure to give 3.30 g of a gummy green solid. The green solid was dissolved in a 50:50 mixture of toluene and hexane and eluted through a 3 cm high, 4.5 cm diameter bed of neutral alumina, leaving behind a red-brown band on the alumina and resulting in an emerald green solution. The green product solution was concentrated to a green solid under reduced pressure resulting in 2.00 g (52%) of green product. The solid green product was then sublimed in an oil bath at 110° C. and 300 mtorr to give 1.38 g (43%) of green crystalline product. See NMR data: ¹H NMR (400 MHz, d₆-benzene, 298K): δ 4.60 (br s, 5H), 1.86 (s, 3H) ppm. ¹³C {¹H} NMR (100 MHz, d₆-benzene, 289K): δ 89.71, 78.34, 76.08, 75.14, 21.76 ppm.

### Example 4

Bis(Toluene)Molybdenum Synthesis with Solvent and Reaction Time Varied. A method similar to Example 2 was performed, with the exception that the initial reflux time of the reaction step forming the [(toluene)₂Mo][AlCl₄] was 4 hours instead of 40 hours.

Example 2 to Example 4 relate to bis (toluene) molybdenum synthesis. In each of the Examples 2 to 4, the solvent and reaction time is varied. Table 1 below summaries the solvents and reaction times employed in each of the Examples 2 to 4.

TABLE 1
Bis(Toluene)Molybdenum Synthesis with Solvent and Reaction Time Varied.

| | | | | Alumina | | |
|---|---|---|---|---|---|---|
| | | | Crude | Purified | | Purified |
| | | Reflux Time for | Yield | Yield | Sublimation | Product |
| | Solvent (reflux | [Toluene)₂Mo][AlCl₄] | (% | (% | Purified % | TGA |
| EX. | Temperature) | formation | yield) | yield) | Yield | Residue |
| 2 | Toluene/Dodecane | 40 h | 3.90 | 1.58 g | 1.38 g | 7 |
| | | (120° C.) | (127%) | (52.0%) | (45.2%) | |
| 3 | Toluene | 40 h | 3.30 | 2.00 g | NA | 12 |
| | | (111° C.) | (108%) | (65.5%) | | |
| 4 | Toluene/Dodecane | 4 h | 3.50 g | NA | 0.8 g | 6 |
| | | (120° C.) | (114%) | | (26%) | |

FIGS. 5A-5C show a stacked ¹H NMR spectra of crude products from Example 2 (FIG. 5A), Example 3 (FIG. 5B), and Example 4 (FIG. 5C), according to some embodiments. In FIG. 5C, 502 corresponds to the aromatic resonances from the product-bound to toluene and 504 corresponds to resonances from the impurity coordinated to tetrahydrofuran. The relative amount of impurities present was much higher in the spectrum corresponding to Example 4 when a shorter reflux time was used. Additionally, the peak width of the aromatic resonances corresponding to the bis (toluene) molybdenum product was understood to be related to the presence of impurities consisting of molybdenum bound to other aromatic impurities or other impurities present which may function as Lewis base type ligands. From these spectra, it can be seen that the crude product with the fewest impurities observed in the ¹H NMR is from Example 3. From these results, it is clear that elution from alumina media led to the removal of many other impurities besides the tetrachloroaluminates present when the reduction of the [(toluene)₂Mo][AlCl₄] is performed using aluminum instead of magnesium.

### Example 5

Bis(Toluene)Molybdenum Synthesis on a 10 g scale with thermal/vacuum treatment of hexanes extract. A 250 mL round bottom flask was equipped with a PTFE coated magnetic stir egg and charged with molybdenum pentachloride (10.00 g, 36.6 mmol, 1.00 eq), aluminum trichloride (5.59 g, 42.0 mmol, 1.15 eq), −325 mesh aluminum powder (1.48 g, 54.9 mmol, 1.50 eq), and toluene (101 g, 1.10 mol, 30 eq). The mixture was stirred for 1 hour to allow the initial exotherm (15° C. to 20° C.) to subside and was then refluxed in an oil bath at 135° C. for 40 hours resulting in the formation of a two-phase reaction mixture. The reaction mixture was allowed to cool and was treated with magnesium powder (5.32 g, 219 mmol, 6.00 eq) and tetrahydrofuran (84 g) in a dropwise fashion over about 15 minutes. The deep green reaction mixture was heated to reflux for 18 hours, allowed to cool, and filtered through a medium porosity fritted funnel. The green-brown filtrates were stripped of solvent under reduced pressure (100 mtorr), extracted with 2 aliquots of 250 mL boiling hexanes, filtered hot over a medium porosity frit, and then stripped of solvent under reduced pressure. The stripped hexane extracts were then analyzed by ¹H NMR which showed the presence of an impurity with resonances corresponding to coordinated tetrahydrofuran (δ 3.89 (br s, 2H), 1.35 (br s, 2H) ppm). This material was then heated under a 100 mtorr vacuum in an oil bath at 100° C. for a total of 3.5 hours. The hexanes extraction process was repeated, followed by stripping under vacuum to give 12.07 g of sticky green residue. The residue was analyzed by ¹H NMR which showed the disappearance of the resonances attributed to impurity-coordinated tetrahydrofuran and was also analyzed by TGA which showed that about 46 wt % of the material (5.6 g) corresponded to the Bis (toluene) Molybdenum product. This residue was purified by vacuum sublimation in a 115° C. to 140° C. oil bath at a pressure of 100 mtorr to give two sublimate fractions: 3.77 g and 2.17 g of the expected Bis(toluene)Molybdenum product (60% overall yield). The TGA analysis of the two fractions indicated a residue of 6.3 and 7.0 percent, respectively.

Use of magnesium as a reductant for the intermediate [(toluene)₂Mo][AlCl₄] achieved good yields and purification by sublimination from the magnesium-reduced product was performed without sacrificing yield.

### Example 6

Synthesis of Bis(toluene)Molybdenum using Aluminum and Magnesium as Sequential Reductants. A 100 mL round bottom flask was equipped with a PTFE coated magnetic stir egg and charged with molybdenum pentachloride (3.00 g, 10.9 mmol, 1.00 eq), aluminum trichloride (1.66 g, 12.5 mmol, 1.15 eq), −325 mesh aluminum powder (1.17, 43.6 mmol, 4.00 eq), toluene (30.1 g, 327 mmol, 30 eq). The mixture was stirred for 1 hour to allow the initial exotherm (15° C. to 20° C.) to subside and was then refluxed in an oil bath at 135° C. for 40 hours resulting in the formation of a two-phase reaction mixture. The reaction mixture was allowed to cool and then treated with tetrahydrofuran (25.0 g) in a dropwise fashion over about 15 minutes. The deep green reaction mixture was heated to reflux for 18 hours, and a small aliquot was removed, stripped of solvent, and analyzed by 1H NMR and ²⁷Al NMR. The ¹H NMR spectrum of this material displayed a resonance corresponding to the methyl group of the toluene ligand as well as tetrahydrofuran resonances corresponding to [AlCl₂(THF)₄] [AlCl₄], but the aromatic protons of toluene were not observed. The ²⁷Al NMR spectrum displayed a resonance at 104.0 ppm corresponding to the [AlCl₂(THF)₄] [AlCl₄], impurity. The reaction mixture was then treated with magnesium powder (1.58 g, 65.3 mmol, 6.00 eq), refluxed an additional 18 hours, filtered through a medium porosity fritted funnel, and stripped of volatiles under reduced pressure. The green-brown filtrates were stripped of solvent under reduced pressure (100 mtorr), heated at 100° C. for 15 minutes under vacuum, and then extracted with a 100 mL aliquot and a 50 ml aliquot of boiling hexanes to give a green solution after filtration. The green solution was stripped of solvent to give 3.24 g of a sticky green solid. This green solid was analyzed by ¹H NMR and ²⁷Al NMR which indicated the formation of the desired product without the [AlCl₂(THF)₄] [AlCl₄], impurity present. ¹H NMR (400 MHz, d₆-benzene, 298 K): δ 4.63 (d, 2H), 4.59 (t, 2H), 4.51 (t, 1H) 1.86 (s, 3H) ppm. ¹³C {¹H} NMR (100 MHz, d₆-benzene, 289 K): δ 89.71, 78.34, 76.08, 75.14, 21.76 ppm.

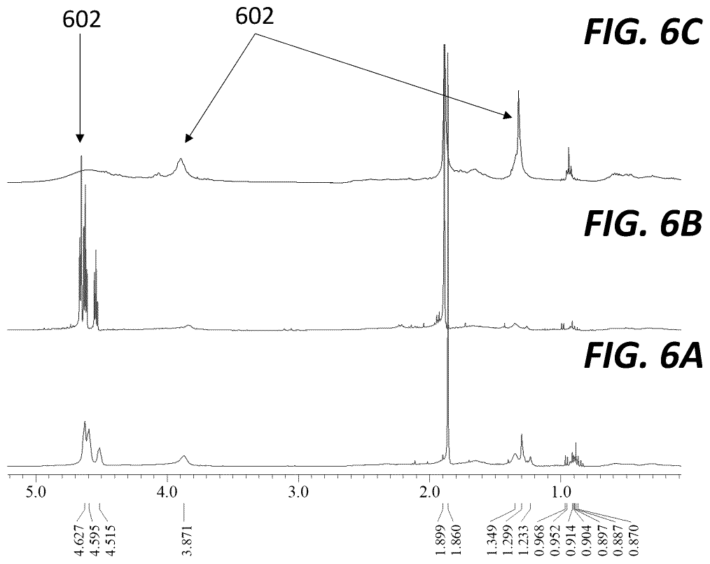

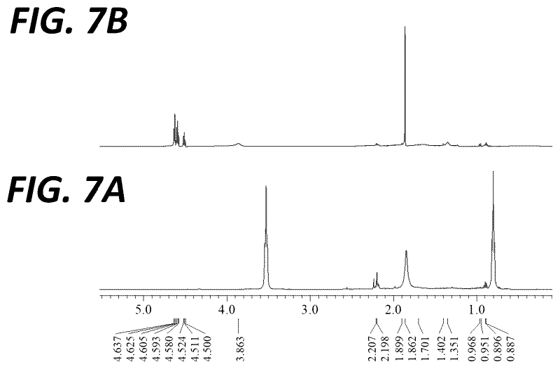

FIGS. 6A-6B show ¹H NMR of crude product after aluminum reduction (FIG. 6A) and after sequential magnesium reduction (FIG. 6B), according to some embodiments. FIGS. 7A-7B show ²⁷Al NMR of crude product after aluminum reduction (FIG. 7A) and after sequential magnesium reduction (FIG. 7B), according to some embodiments.

### Example 7

Synthesis of Bis(Toluene)Molybdenum on a 36 g scale with Aluminum as a reductant and a split batch purification comparison. A 3-neck, 1 L round bottom flask was charged with molybdenum pentachloride (36.0 g, 131 mmol, 1.00 eq), aluminum trichloride (19.9 g, 150 mmol, 1.15 eq), −325 mesh aluminum powder (14.1 g, 524 mmol, 4.00 eq), toluene (350 g, 3.80 mol, 29 eq). The flask was equipped with a mechanical stirrer setup (glass stir shaft, PTFE stirrer bearing, PTFE stir paddle) and stirred around 250 RPM. The mixture was stirred for about 30 minutes to allow the initial exotherm (5° C. to 10° C.) to subside and was then refluxed in an oil bath at 135° C. for 40 hours resulting in the formation of a two-phase reaction mixture. The reaction mixture was allowed to cool and then treated with tetrahydrofuran (302 g) slowly over approximately 2 hours. The reaction mixture was then refluxed for 18 hours, allowed to cool, and filtered through a medium porosity fritted funnel. The green-brown filtrates were stripped of solvent under reduced pressure (100 mtorr), extracted with 2 aliquots of 250 mL boiling hexanes, filtered hot over a medium porosity frit, and then stripped of solvent under reduced pressure yielding 114 g of crude material. This crude product was extracted with boiling pentane (500 mL, 4×, 2 L total) and filtered to give a green solution. The solvent was evaporated from this solution under reduced pressure to give 20.10 g (55% pentane extracted crude yield) of a green solid. This green solid was analyzed by ¹H NMR and ²⁷Al NMR which showed that the [AlCl₂(THF)₄] [AlCl₄] impurity was present in addition to the product. The pentane extracted crude product was then split up into 6 approximately equal masses and were purified according to the methods shown in Table 2 below. As shown in Table 2, passing the bis (arene) molybdenum complexes through adsorption media was superior to recrystallization at least with respect to purity and yield of the product isolated. Sublimination of an impure product was also observed to result in lower yields and lower purity.

TABLE 2

| | | | | | TGA | | |
|---|---|---|---|---|---|---|---|
| | | | TGA | | Less | | Al |
| | | | Wt % | | Volatile | TGA | Species |
| | | | More | TGA | Impurities | Overall | Present |
| | | % | Volatile | Wt % | (~200- | Residue | in 27Al |
| Entry | Treatment | Yield | Impurities | Product | 300° C.) | (>500° C.) | NMR? |
| 1 | NA (Crude) | 310 | 1 | 40 | 13 | 46 | Yes |
| 2 | NA (Pentane | 55 | 3 | 52 | 17 | 28 | Yes |
| | Extracts) | | | | | | |
| 3 | Neutral | 19 | <1 | 84 | <1 | 15 | No |
| | Alumina | | | | | | |
| 4 | Acidic | 17 | <1 | 82 | <1 | 17 | No |
| | Alumina | | | | | | |
| 5 | Basic Alumina | 19 | <1 | 81 | <1 | 17 | No |
| 6 | Silica Gel | 17 | <2 | 78 | <1 | 20 | No |
| 7 | Florisil | 15 | <1 | 80 | <1 | 18 | No |
| 8 | Recrystallized | 37 | <3 | 33 | 33 | 32 | Yes |
| 9 | Sublimed | 9 | <1 | 58 | 13 | 28 | No |
| | (from recryst. | | | | | | |
| | material) | | | | | | |

### Example 8

Independent synthesis of [AlCl2(THF)4][AlCl4]. 1.0 g of AlCl₃ (7.50 mmol, 1 eq) was weighed into a clear, 40 ml scintillation vial containing a micro stir bar. 10 ml of toluene was added to the vial and the mixture agitated to dissolve the solid. The reaction mixture was heated and stirred while 1.1 g (15.0 mmol, 2 eq) of THF was added in a dropwise fashion. The reaction mixture was heated for two hours at 100° C., and the solvent was allowed to slowly evaporate to give a colorless crystalline solid which was analyzed by NMR and shown to match the dominant aluminum species generated as an impurity in the Bis(toluene)Molybdenum synthesis. See NMR data: ¹H NMR (400 MHz, d₆-benzene, 298 K): δ 3.58 (s, 2H), 0.88 (s, 2H) ppm. ¹³C {1H} NMR (100 MHz, d₆-benzene, 289 K): δ 74.39, 24.67 ppm. ²⁷Al NMR (104 MHz, d₆-benzene, 289 K): δ 104.0 ppm.

### Example 9

Synthesis of bis(toluene)molybdenum from MoCl₅ at a 50 g scale. A 3 L round bottom flask was charged with molybdenum pentachloride (50.548 g, 185 mmol, 1.0 eq), aluminum trichloride (56.176 g, 421 mmol, 2.28 eq), and aluminum powder (7.395 g, 274 mmol, 1.48 eq). The flask was charged with toluene (505 g, 5.48 mol, 29.6 eq), and the reaction mixture was stirred 1 hour at ambient temperature. The reaction mixture was stirred and heated at reflux for 24 h. The reaction mixture was allowed to cool, then chilled in an ice bath, charged with magnesium powder (31.13 g, 1.28 mol, 6.91 eq) and tetrahydrofuran (422 g) in a dropwise fashion so that the internal temperature did not exceed 25° C. The reaction was heated to reflux (˜86° C.) for 18 hours and then allowed to cool to ambient temperature. The reaction mixture was filtered over to a 2 L round bottom flask and the residual salts were washed with 300 mL of anhydrous toluene. The combined filtrates were stripped of solvent under reduced pressure to give a dark green-brown solid. The crude solid was extracted 2× with hot (50° C.) anhydrous hexanes (1224 g aliquot and 578 g aliquot), and successively filtered after each hot extraction to give a clear green product solution in hexanes. The combined filtrates from the hot hexanes washes were stripped of solvent to give 50.2 g of product. The hexanes extracted product was dissolved in a solution of 300 mL toluene and 200 ml hexanes, cooled to about 5° C. in an ice bath, and treated with 60 mL of degassed deionized water in a dropwise fashion. This resulted in the formation of a light precipitate that was filtered away using a medium porosity filter funnel. The purified filtrates were then stripped of toluene under reduced pressure to give 27.3 g of green solid that was 92% pure by ¹H NMR (quantitation vs hexamethyldisiloxane internal standard). The TGA analysis of the product indicated a purity of 88% based on the residual mass. The yield of the reaction based the ¹H NMR weighted purity was 49%.

### Example 10

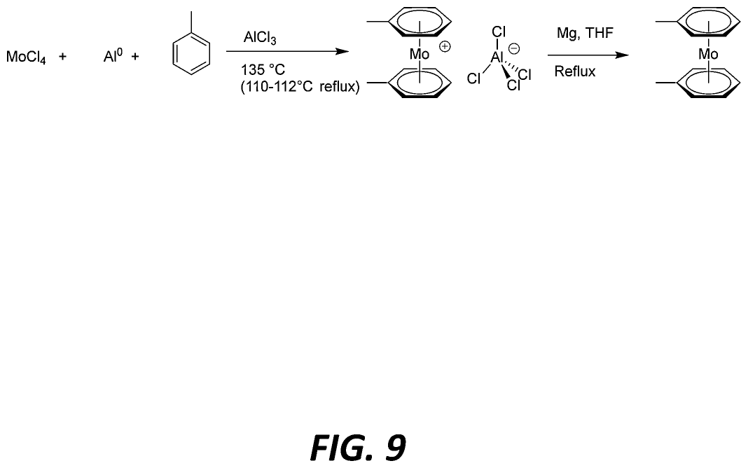

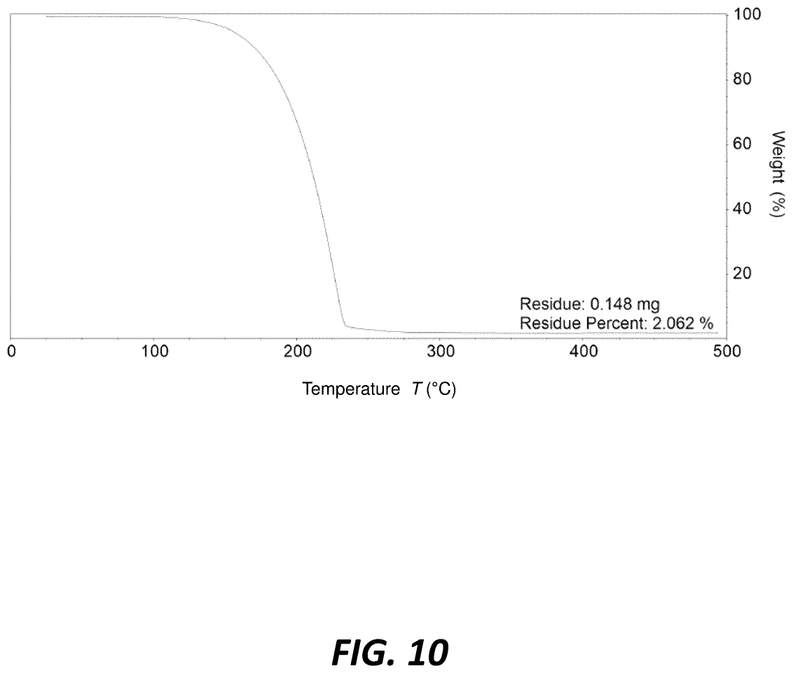

Synthesis of bis(toluene)molybdenum from MoCl₄ at a 50 g scale which follows the reaction scheme of FIG. 9. A 2 L reaction flask was charged with MoCl₄ (50.0 g 210 mmol, 1.00 eq), aluminum chloride (50.3 g, 378 mmol, 1.80 eq), aluminum powder (6.50 g, 241 mmol, 1.15 eq) and toluene (580 g, 6.3 mol, 30.0 eq). The reaction mixture was stirred and heated to reflux in a 135° C. oil bath for 41 hours. The reaction mixture was allowed to cool, then chilled in an ice bath, charged with magnesium powder (28.0 g, 1.155 mol, 5.50 eq) and tetrahydrofuran (484 g, 6.72 mol, 32.0 eq) in a dropwise fashion. The reaction was heated to reflux (˜86° C.) for 8 hours. It was then allowed to cool and sit for about 72 h. The solvent was then distilled away from the reaction mixture under reduced pressure to near dryness. The resulting green solid was then dissolved in about 500 mL of anhydrous toluene and filtered through a medium porosity fritted funnel to give a green solution. The filtrates were then stripped of toluene under reduced pressure to give 79.36 g of a sticky green solid that was analyzed for purity by ¹H NMR (quantitation versus hexamethyldisiloxane internal standard) and by TGA which indicated 49% and 50% purity, respectively. The sticky green solid was dissolved in about 400 mL of toluene, cooled in an ice bath to about 5° C., and then treated with 20 mL of degassed, deionized water over 45 minutes with vigorous stirring such that the internal temperature did not exceed 20° C. This resulted in the formation of a light precipitate that was filtered away using a medium porosity filter funnel. The purified filtrates were then stripped of toluene under reduced pressure to give 47.31 g of green solid that was 85% pure by ¹H NMR. The green solid was transferred to a sublimation apparatus and further purified by sublimation (120-140° C., 100 mtorr) to give 36.3 g bis(toluene)molybdenum with a purity of 94% by ¹H NMR and 97% by TGA as shown in FIG. 10.

### Example 11

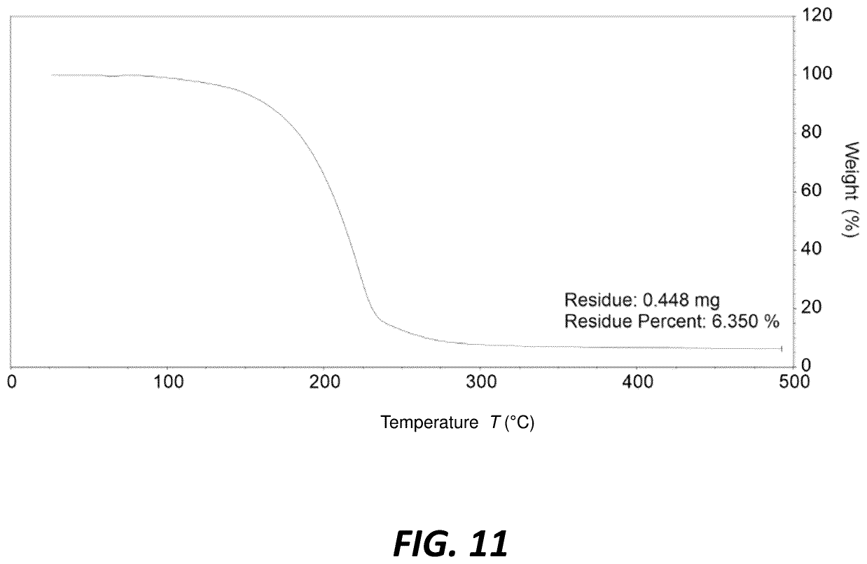

Synthesis of bis (toluene) molybdenum from molybdenum tetrachloride on a 10 g scale which follows the reaction scheme of FIG. 9. A 500 mL 3-neck round bottom flask was charged with molybdenum tetrachloride (10 g, 42.0 mmol, 1.0 eq), aluminum trichloride (9.99 g, 75.0 mmol, 1.79 eq), aluminum powder (1.30 g, 48.3 mmol, 1.15 eq), and toluene (116 g, 1260 mmol, 30.0 eq). The reaction mixture was stirred and heated to reflux for 44 hours. The reaction mixture was allowed to cool, then chilled in an ice bath, charged with magnesium powder (5.61 g, 231 mol, 5.50 eq) and about 100 mL anhydrous tetrahydrofuran in a dropwise fashion keeping the internal temperature below 20° C. The reaction was heated to reflux (˜87° C.) for 17 hours than allowed to cool to ambient temperature. The solvent was then distilled away under reduced pressure until the mixture had reached near dryness. The crude product was then extracted with 400 mL of toluene, and filtered to a 1 L flask through a medium porosity frit. The residual salts were washed with 4 100 mL aliquots of toluene and successively filtered to give about 800 mL of a green product solution. The green product solution was cooled in an ice bath, vigorously stirred, and treated with 15 mL of degassed deionized water in a dropwise fashion over 1 h. The mixture was treated with about 5 g of anhydrous magnesium sulfate, then filtered to remove the precipitate. The filtrates were stripped of solvent under reduced pressure to give 11.15 g of bis (toluene) molybdenum with a purity of 82% by ¹H NMR (78% yield). TGA analysis of the product showed 6% overall residue with 85% of the volatile residue due to the bis (toluene) molybdenum weight transition as shown in FIG. 11.

Aspects

Various Aspects are described below. It is to be understood that any one or more of the features recited in the following Aspect(s) can be combined with any one or more other Aspect(s).

### Aspect 1.

A method comprising:
contacting a metal halide, with a first metal component and an aluminum halide, in a first solvent, to form a reaction mixture comprising an intermediate complex;
contacting the intermediate complex, with a second metal component, in a reaction mixture comprising a second solvent, to form a reaction mixture comprising a bis (arene) metal complex; and
obtaining a product;
   wherein the product comprises a purified bis (arene) metal complex with less than 10% impurities.
      Aspect 2. The method of Aspect 1, wherein obtaining the product includes conducting a post synthesis aqueous extraction on the reaction mixture.
      Aspect 3. A method comprising:
contacting a metal halide, with a first metal component and an aluminum halide, in a first solvent, so as to form a reaction mixture comprising an intermediate complex;
contacting the intermediate complex, with a second metal component, in a reaction mixture comprising a second solvent, so as to form a reaction mixture comprising a bis (arene) metal complex; and
contacting the reaction mixture comprising the bis (arene) metal complex, with a separation media, so as to obtain a product,
   wherein the product comprises a purified bis (arene) metal complex and less than 10% impurities.
      Aspect 4. The method according to Aspect 1-3, wherein the contacting of the metal halide proceeds at least at a temperature of 50° C. to 200° C.
      Aspect 5. The method according to any one of Aspects 1-4, wherein the metal halide comprises at least one of MoCl₂, MoCl₃, MoCl₄, MoCl₅, MoCl₆, CrCl₂, CrCl₃, WCl₂, WCl₃, WCl₄, WCl₅, WCl₆, or any combination thereof.
      Aspect 6. The method according to any one of Aspects 1-5, wherein the first metal component comprises at least one of Li, Na, K, Rb, Cs, Mg, Ca, Cd, Sr, Ba, Al, Ga, In, Zn, Sn, or any combination thereof.
      Aspect 7. The method according to any one of Aspects 1-6, wherein the aluminum halide comprises at least one of aluminum chloride, aluminum bromide, aluminum iodide, or any combination thereof.
      Aspect 8. The method according to any one of Aspects 1-7, wherein the first solvent comprises a compound of the formula:

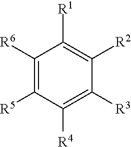

where:
   R¹, R², R³, R⁴, R⁵, and R⁶ are each independently a hydrogen, an alkyl, an alkenyl, an alkynyl, a cycloalkyl, or an aryl; or
      wherein two of R¹, R², R³, R⁴, R⁵, and R⁶ are optionally bonded to form a 6-membered aryl.
         Aspect 9. The method according to any one of Aspects 1-7, wherein the first solvent comprises a compound of the formula:

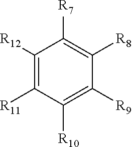

where:
   R⁷, R⁸, R⁹, R¹⁰, R¹¹, and R¹² are each independently a hydrogen, an alkyl, an alkenyl, an alkynyl, a cycloalkyl, or an aryl;
      wherein two of R⁷, R⁸, R⁹, R¹⁰, R¹¹, and R¹² are optionally bonded to form a 6-membered aryl.
         Aspect 10. The method according to any one of Aspects 1-9, wherein the first solvent is an aromatic solvent comprising at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.
         Aspect 11. The method according to any one of Aspects 1-10, wherein the intermediate complex is a complex of the formula:

[bis(first solvent) metal]⁺[aluminum halide]⁻,
wherein the metal is Mo, Cr, or W;
wherein the halide is CI, Br, or I.
   Aspect 12. The method according to any one of Aspects 1-11, wherein the contacting of the intermediate complex proceeds at a temperature of 0° C. to 150° C. Aspect 13. The method according to any one of Aspects 1-12, wherein the second metal component comprises at least one of Li, Na, K, Rb, Cs, Mg, Ca, Cd, Sr, Ba, Al, Ga, In, Zn, Sn, or any combination thereof.
   Aspect 14. The method according to any one of Aspects 1-13, wherein the second solvent is an ethereal solvent comprising at least one of tetrahydrofuran, methyl tetrahydrofuran, dimethoxyethane (DME), triglyme, diethylether, diisopropylether, dibutyl ether, cyclopentylmethyl ether, methyl tert-butyl ether (MTBE), or any combination thereof.
   Aspect 15. The method according to any one of Aspects 1-14, wherein the bis (arene) metal complex comprises a compound of the formula:

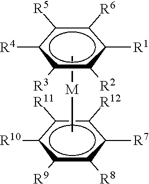

where:
   M is Mo, Wo, or Cr;
   R¹, R², R³, R⁴, R⁵, and R⁶ are each independently a hydrogen, an alkyl, an alkenyl, an alkynyl, a cycloalkyl, or an aryl;
      wherein two of R¹, R², R³, R⁴, R⁵, and R⁶ are optionally bonded to form a 6-membered aryl;
   R⁷, R⁸, R⁹, R¹⁰, R¹¹, and R¹² are each independently a hydrogen, an alkyl, an alkenyl, an alkynyl, a cycloalkyl, or an aryl;
      wherein two of R⁷, R⁸, R⁹, R¹⁰, R¹¹, and R¹² are optionally bonded to form a 6-membered aryl.
         Aspect 16. The method according to any one of Aspects 1-14, wherein the bis (arene) metal complex comprises at least one of the following: a bis (benzene) metal complex, a bis (toluene) metal complex, a bis (xylene) metal complex, a bis (butyltoluene) metal complex, a bis (ethyl methyl benzene) metal complex, a bis (ethyl methylbenzene) metal complex, a bis (isopropyl methyl benzene) metal complex, a bis (butyl methylbenzene) metal complex, a bis (mesitylene) metal complex, a bis (pseudocumene) metal complex, a bis (durene) metal complex, a bis (methylbenzene) metal complex, a bis (dimethylbenzene) metal complex, a bis (trimethylbenzene) metal complex, a bis (ethylbenzene) metal complex, a bis (1,4-diethylbenzene) metal complex, a bis (triethylbenzene) metal complex, a bis (propylbenzene) metal complex, a bis (butylbenzene) metal complex, a bis (iso-butylbenzene) metal complex, a bis (sec-butylbenzene) metal complex, a bis (t-butylbenzene) metal complex, a bis (hexylbenzene) metal complex, a bis (styrene) metal complex, a bis (naphthalene) metal complex, a bis (anthracene) metal complex, a bis (phenanthrene) metal complex, a bis (biphenyl) metal complex, a bis (terphenyl) metal complex, a bis (methylnaphthalene) metal complex, a bis (biphenylene) metal complex, a bis (dimethylnaphthalene) metal complex, a bis (methylanthracene) metal complex, a bis (4,4′-dimethylbiphenyl) metal complex, a bis (bibenzyl) metal complex, a bis (diphenylmethane) metal complex, any isomer thereof, or any combination thereof.
         Aspect 17. The method according to any one of Aspects 1-16, wherein the separation media comprises at least one of neutral alumina, acidic alumina, basic alumina, magnesium silicate, silica, or any combination thereof.
         Aspect 18. The method according to any one of Aspects 1-17, wherein the product comprises 1% to 2% impurities.
         Aspect 19. The method according to any one of Aspects 1-′18, wherein the product comprises 0.01% to 2% impurities.
         Aspect 20. The method according to any one of Aspects 1-19, wherein the impurities comprise at least one of an aluminum halide, a tetrahydrofuran coordinated to an aluminum halide, a coupled arene compound, or any combination thereof.
         Aspect 21. The method according to Aspect 20, wherein the coupled arene compound comprises a compound of the formula:

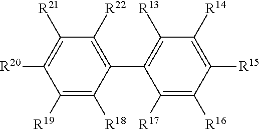

where:
   R¹³, R¹⁴, R¹⁵, R¹⁶, R¹⁷, R¹⁸, R¹⁹, R²⁰, R²¹, and R²² are each independently a hydrogen, an alkyl, an alkenyl, an alkynyl, a cycloalkyl, or an aryl.
      Aspect 22. The method according to any one of Aspects 1-20, wherein the product comprises an undetectable level of an aluminum halide as determined by ²⁷Al NMR spectroscopy.
      Aspect 23. A method of synthesis comprising:
contacting a metal halide, with a first metal component and an aluminum halide, in a first solvent, so as to form a reaction comprising an intermediate complex; and
contacting the intermediate complex, with a second metal component, in a reaction mixture comprising a second solvent, so as to form a reaction mixture comprising a bis (arene) metal complex.
   Aspect 24. The method according to Aspect 23, wherein the metal halide comprises at least one of MoCl₂, MoCl₃, MoCl₄, MoCl₅, MoCl₆, CrCl₂, CrCl₃, WCl₂, WCl₃, WCl₄, WCl₅, WCl₆, or any combination thereof.
   Aspect 25. The method according to any one of Aspects 23-24, wherein the first metal component comprises at least one of Li, Na, K, Rb, Cs, Mg, Ca, Cd, Sr, Ba, Al, Ga, In, Zn, Sn, or any combination thereof.
   Aspect 26. The method according to any one of Aspects 23-25, wherein the aluminum halide comprises at least one of aluminum chloride, aluminum bromide, aluminum iodide, or any combination thereof.
   Aspect 27. The method according to any one of Aspects 23-26, wherein the first solvent comprises:
a compound of the formula:

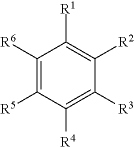

where:
   R¹, R², R³, R⁴, R⁵, and R⁶ are each independently a hydrogen, an alkyl, an alkenyl, an alkynyl, a cycloalkyl, or an aryl; or
      wherein two of R¹, R², R³, R⁴, R⁵, and R⁶ are optionally bonded to form a 6-membered aryl; or
a compound of the formula:

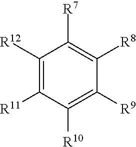

where:
   R⁷, R⁸, R⁹, R¹⁰, R¹¹, and R¹² are each independently a hydrogen, an alkyl, an alkenyl, an alkynyl, a cycloalkyl, or an aryl;
      wherein two of R⁷, R⁸, R⁹, R¹⁰, R¹¹, and R¹² are optionally bonded to form a 6-membered aryl.
         Aspect 28. The method according to any one of Aspects 23-27, wherein the intermediate complex is a complex of the formula:

[bis (first solvent) metal]⁺[aluminum halide]⁻,
wherein the metal is Mo, Cr, or W;
wherein the halide is Cl, Br, or I.
   Aspect 29. The method according to any one of Aspects 23-28, wherein the second metal component comprises at least one of Li, Na, K, Rb, Cs, Mg, Ca, Cd, Sr, Ba, Al, Ga, In, Zn, Sn, or any combination thereof.
   Aspect 30. The method according to any one of Aspects 23-29, wherein the second solvent is an ethereal solvent comprising at least one of tetrahydrofuran, methyl tetrahydrofuran, dimethoxyethane (DME), triglyme, diethylether, diisopropylether, dibutyl ether, cyclopentylmethyl ether, methyl tert-butyl ether (MTBE), or any combination thereof.
   Aspect 31. The method according to any one of Aspects 23-30, wherein the bis (arene) metal complex comprises a compound of the formula:

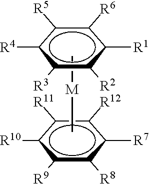

where:
   M is Mo, Wo, or Cr;
   R¹, R², R³, R⁴, R⁵, and R⁶ are each independently a hydrogen, an alkyl, an alkenyl, an alkynyl, a cycloalkyl, or an aryl;
      wherein two of R¹, R², R³, R⁴, R⁵, and R⁶ are optionally bonded to form a 6-membered aryl;
   R⁷, R⁸, R⁹, R¹⁰, R¹¹, and R¹² are each independently a hydrogen, an alkyl, an alkenyl, an alkynyl, a cycloalkyl, or an aryl;
      wherein two of R⁷, R⁸, R⁹, R¹⁰, R¹¹, and R¹² are optionally bonded to form a 6-membered aryl.
         Aspect 32. The method according to any one of Aspects 23-31, wherein the reaction mixture comprising the bis (arene) metal complex does not comprise a detectable level of [AlCl₂(THF)₄]⁺[AlCl₄]⁻.
         Aspect 33. A method of purification comprising:
obtaining a reaction mixture comprising a bis (arene) metal complex and at least one impurity; and
contacting the reaction mixture comprising the bis (arene) metal complex, with a separation media, so as to obtain a product,
   wherein the product comprises a purified bis (arene) metal complex,
   wherein the product comprises less of the at least one impurity on a weight basis than the reaction mixture comprising the bis (arene) metal complex.
      Aspect 34. The method according to Aspect 33, wherein the bis (arene) metal complex comprises a compound of the formula:

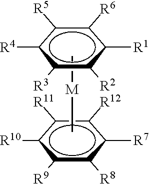

where:
   M is Mo, Wo, or Cr;
   R¹, R², R³, R⁴, R⁵, and R⁶ are each independently a hydrogen, an alkyl, an alkenyl, an alkynyl, a cycloalkyl, or an aryl;
      wherein two of R¹, R², R³, R⁴, R⁵, and R⁶ are optionally bonded to form a 6-membered aryl;
   R⁷, R⁸, R⁹, R¹⁰, R¹¹, and R¹² are each independently a hydrogen, an alkyl, an alkenyl, an alkynyl, a cycloalkyl, or an aryl;
      wherein two of R⁷, R⁸, R⁹, R¹⁰, R¹¹, and R¹² are optionally bonded to form a 6-membered aryl.
         Aspect 35. The method according to any one of Aspects 33-34, wherein the at least one impurity comprises at least one of a metal halide, an arene coordinated to a metal halide, a metal halide complex, or any combination thereof.
         Aspect 36. The method according to any one of Aspects 33-35, wherein the at least one impurity comprises at least one of an aluminum halide, a tetrahydrofuran coordinated to an aluminum halide, an aluminum halide complex, a coupled arene compound, or any combination thereof.
         Aspect 37. The method according to any one of Aspects 33-36, wherein the reaction mixture comprising the bis (arene) metal complex does not comprise a detectable level of [AlCl₂(THF)₄]⁺[AlCl₄]⁻.
         Aspect 38. The method according to any one of Aspects 33-37, wherein the reaction mixture comprising the bis (arene) metal complex comprises a solvent for dissolving the bis (arene) metal complex.
         Aspect 39. The method according to any one of Aspects 33-38, wherein the reaction mixture comprising the bis (arene) metal complex comprises at least one of toluene, hexane, or any combination thereof.
         Aspect 40. The method according to any one of Aspects 33-39, wherein the separation media comprises at least one of neutral alumina, acidic alumina, basic alumina, magnesium silicate, silica, or any combination thereof.
         Aspect 41. The method according to any one of Aspects 33-40, wherein the product has no more than 10% by weight of the at least one impurity based on a total weight of the product.
         Aspect 42. The method according to any one of Aspects 33-41, wherein the product has no more than 2% by weight of the at least one impurity based on a total weight of the product.
         Aspect 43. A composition comprising: a bis (arene) metal complex of the following formula:

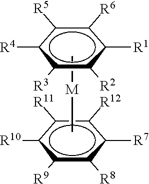

where:
   M is Mo, Wo, or Cr;
   R¹, R², R³, R⁴, R⁵, and R⁶ are each independently a hydrogen, an alkyl, an alkenyl, an alkynyl, a cycloalkyl, or an aryl;
      wherein two of R¹, R², R³, R⁴, R⁵, and R⁶ are optionally bonded to form a 6-membered aryl;
   R⁷, R⁸, R⁹, R¹⁰, R¹¹, and R¹² are each independently a hydrogen, an alkyl, an alkenyl, an alkynyl, a cycloalkyl, or an aryl;
      wherein two of R⁷, R⁸, R⁹, R¹⁰, R¹¹, and R¹² are optionally bonded to form a 6-membered aryl.
         Aspect 44. The composition of Aspect 43, wherein the bis (arene) metal complex comprises less than 10% impurities.
         Aspect 45. The composition of Aspect 43-44, wherein the bis (arene) metal complex comprises less than 5% impurities.
         Aspect 46. The composition of Aspect 43-45, wherein the bis (arene) metal complex comprises less than 1% impurities.
         Aspect 47. The composition of Aspect 43-46, wherein the impurities comprise at least one of an aluminum halide, a tetrahydrofuran coordinated to an aluminum halide, a coupled arene compound, a methylene bridged arene, or any combination thereof.
         Aspect 48. The composition of Aspect 43-47, wherein the impurities includes at least one of the following compounds:

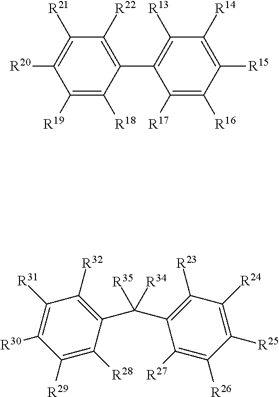

where: R¹³, R¹⁴, R¹⁵, R¹⁶, R¹⁷, R¹⁸, R¹⁹, R²⁰, R²¹, and R²² are each independently a hydrogen, an alkyl, an alkenyl, an alkynyl, a cycloalkyl, or an aryl and R²³, R²⁴, R²⁵, R²⁶, R²⁷, R²⁸, R²⁹, R³⁰, R³¹, R³², R³³, and R³⁴ are each independently a hydrogen, an alkyl, an alkenyl, an alkynyl, a cycloalkyl, or an aryl; magnesium halides, aluminum halides, alkali metal halides, alkaline earth metal halides, aryl magnesium halides, aryl aluminums, aryl aluminum halides, aluminum halide tetrahydrofuran complexes, aryl magnesium halide tetrahydrofuran complexes, halogenated metal compounds, anionic aryl metal complexes with alkali metal cations, anionic aryl metal complexes with alkaline earth metal cations, oligomeric metal compounds consisting of the metal coordinated by compounds of the formulae:

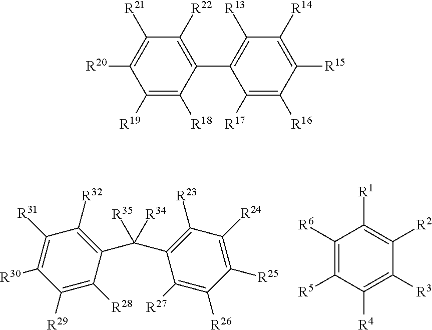

where:
   M is Mo, Wo, or Cr;
   R¹, R², R³, R⁴, R⁵, and R⁶ are each independently a hydrogen, an alkyl, an alkenyl, an alkynyl, a cycloalkyl, or an aryl;
      wherein two of R¹, R², R³, R⁴, R⁵, and R⁶ are optionally bonded to form a 6-membered aryl;
where:
   R¹³, R¹⁴, R¹⁵, R¹⁶, R¹⁷, R¹⁸, R¹⁹, R²⁰, R²¹, and R²² are each independently a hydrogen, an alkyl, an alkenyl, an alkynyl, a cycloalkyl, or an aryl
where:
   R²³, R²⁴, R²⁵, R²⁶, R²⁷, R²⁸, R²⁹, R³⁰, R³¹, R³², R³³, and R³⁴ are each independently a hydrogen, an alkyl, an alkenyl, an alkynyl, a cycloalkyl, or an aryl.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method comprising:
contacting a metal halide, with a first metal component and an aluminum halide, in a first solvent, to form a reaction mixture comprising an intermediate complex;
contacting the intermediate complex, with a second metal component, in a reaction mixture comprising a second solvent, to form a reaction mixture comprising a bis (arene) metal complex; and
obtaining a product;
wherein the product comprises a purified bis (arene) metal complex with less than 10% impurities.

2. The method of claim 1, wherein the contacting of the metal halide proceeds at least at a temperature of 50° C. to 200° C.

3. The method of claim 1, wherein the metal halide comprises at least one of MoCl₂, MoCl₃, MoCl₄, MoCl₅, MoCl₆, CrCl₂, CrCl₃, WCl₂, WCl₃, WCl₄, WCl₅, WCl₆, or any combination thereof.

4. The method of claim 1, wherein the first metal component comprises at least one of Li, Na, K, Rb, Cs, Mg, Ca, Cd, Sr, Ba, Al, Ga, In, Zn, Sn, or any combination thereof.

5. The method of claim 1, wherein the aluminum halide comprises at least one of aluminum chloride, aluminum bromide, aluminum iodide, or any combination thereof.

6. The method of claim 1, wherein the first solvent comprises a compound of the formula: 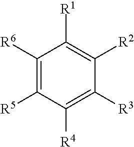
where:
R¹, R², R³, R⁴, R⁵, and R⁶ are each independently a hydrogen, an alkyl, an alkenyl, an alkynyl, a cycloalkyl, or an aryl; or
wherein two of R¹, R², R³, R⁴, R⁵, and R⁶ are optionally bonded to form a 6-membered aryl.

7. The method of claim 1, wherein the first solvent comprises a compound of the formula: 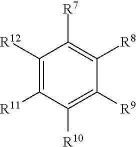
where:
R⁷, R⁸, R⁹, R¹⁰, R¹¹, and R¹² are each independently a hydrogen, an alkyl, an alkenyl, an alkynyl, a cycloalkyl, or an aryl;
wherein two of R⁷, R⁸, R⁹, R¹⁰, R¹¹, and R¹² are optionally bonded to form a 6-membered aryl.

8. The method of claim 1, wherein the first solvent is an aromatic solvent comprising at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.

9. The method of claim 1, wherein the intermediate complex is a complex of the formula:
[bis (first solvent) metal]⁺[aluminum halide]⁻,
wherein the metal is Mo, Cr, or W;
wherein the halide is CI, Br, or I.

10. The method of claim 1, wherein obtaining the product includes conducting a post synthesis aqueous extraction on the reaction mixture.

11. The method of claim 10, wherein the product is further purified by using a separation media.

12. The method of claim 1, wherein obtaining the product includes contacting the reaction mixture comprising the bis (arene) metal complex with a separation media.

13. The method of claim 1, wherein the bis (arene) metal complex comprises a compound of the formula: 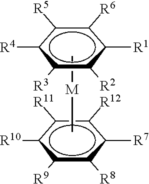
where:
M is Mo, Wo, or Cr;
R¹, R², R³, R⁴, R⁵, and R⁶ are each independently a hydrogen, an alkyl, an alkenyl, an alkynyl, a cycloalkyl, or an aryl;
wherein two of R¹, R², R³, R⁴, R⁵, and R⁶ are optionally bonded to form a 6-membered aryl;
R⁷, R⁸, R⁹, R¹⁰, R¹¹, and R¹² are each independently a hydrogen, an alkyl, an alkenyl, an alkynyl, a cycloalkyl, or an aryl;
wherein two of R⁷, R⁸, R⁹, R¹⁰, R¹¹, and R¹² are optionally bonded to form a 6-membered aryl.

14. The method of claim 1, wherein the bis (arene) metal complex comprises at least one of the following: a bis (benzene) metal complex, a bis (toluene) metal complex, a bis (xylene) metal complex, a bis (butyltoluene) metal complex, a bis (ethyl methyl benzene) metal complex, a bis (ethyl methylbenzene) metal complex, a bis (isopropyl methyl benzene) metal complex, a bis (butyl methylbenzene) metal complex, a bis (mesitylene) metal complex, a bis (pseudocumene) metal complex, a bis (durene) metal complex, a bis (methylbenzene) metal complex, a bis (dimethylbenzene) metal complex, a bis (trimethylbenzene) metal complex, a bis (ethylbenzene) metal complex, a bis (1,4-diethylbenzene) metal complex, a bis (triethylbenzene) metal complex, a bis (propylbenzene) metal complex, a bis (butylbenzene) metal complex, a bis (iso-butylbenzene) metal complex, a bis (sec-butylbenzene) metal complex, a bis (t-butylbenzene) metal complex, a bis (hexylbenzene) metal complex, a bis (styrene) metal complex, a bis (naphthalene) metal complex, a bis (anthracene) metal complex, a bis (phenanthrene) metal complex, a bis (biphenyl) metal complex, a bis (terphenyl) metal complex, a bis (methylnaphthalene) metal complex, a bis (biphenylene) metal complex, a bis (dimethylnaphthalene) metal complex, a bis (methylanthracene) metal complex, a bis (4,4′-dimethylbiphenyl) metal complex, a bis (bibenzyl) metal complex, a bis (diphenylmethane) metal complex, any isomer thereof, or any combination thereof.

15. A composition comprising:
a bis (arene) metal complex of the following formula: 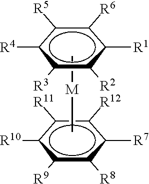
where:
M is Mo, Wo, or Cr;
R¹, R², R³, R⁴, R⁵, and R⁶ are each independently a hydrogen, an alkyl, an alkenyl, an alkynyl, a cycloalkyl, or an aryl;
wherein two of R¹, R², R³, R⁴, R⁵, and R⁶ are optionally bonded to form a 6-membered aryl;
R⁷, R⁸, R⁹, R¹⁰, R¹¹, and R¹² are each independently a hydrogen, an alkyl, an alkenyl, an alkynyl, a cycloalkyl, or an aryl;
wherein two of R⁷, R⁸, R⁹, R¹⁰, R¹¹, and R¹² are optionally bonded to form a 6-membered aryl.

16. The composition of claim 15, wherein the bis (arene) metal complex comprises less than 10% impurities.

17. The composition of claim 15, wherein the bis (arene) metal complex comprises less than 5% impurities.

18. The composition of claim 15, wherein the bis (arene) metal complex comprises less than 1% impurities.

19. The composition of claim 16, wherein the impurities comprise at least one of an aluminum halide, a tetrahydrofuran coordinated to an aluminum halide, a coupled arene compound, a methylene bridged arene, or any combination thereof.

20. The composition of claim 16, wherein the impurities includes at least one of the following compounds: 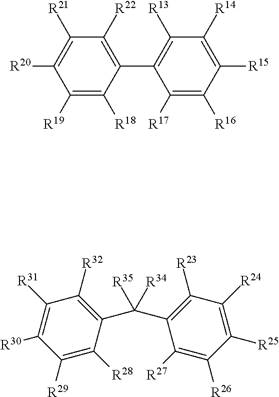
where: R¹³, R¹⁴, R¹⁵, R¹⁶, R¹⁷, R¹⁸, R¹⁹, R²⁰, R²¹, and R²² are each independently a hydrogen, an alkyl, an alkenyl, an alkynyl, a cycloalkyl, or an aryl and R²³, R²⁴, R²⁵, R²⁶, R²⁷, R²⁸, R²⁹, Rao, R³¹, R³², R³³, and R³⁴ are each independently a hydrogen, an alkyl, an alkenyl, an alkynyl, a cycloalkyl, or an aryl; magnesium halides, aluminum halides, alkali metal halides, alkaline earth metal halides, aryl magnesium halides, aryl aluminums, aryl aluminum halides, aluminum halide tetrahydrofuran complexes, aryl magnesium halide tetrahydrofuran complexes, halogenated metal compounds, anionic aryl metal complexes with alkali metal cations, anionic aryl metal complexes with alkaline earth metal cations, oligomeric metal compounds consisting of the metal coordinated by compounds of the formulae: 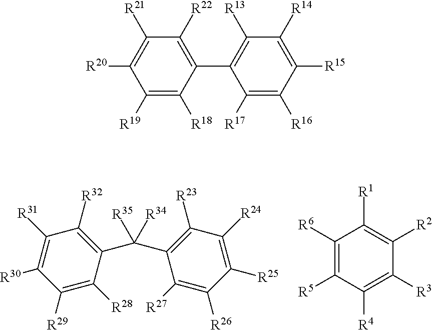
where:
M is Mo, Wo, or Cr;
R¹, R², R³, R⁴, R⁵, and R⁶ are each independently a hydrogen, an alkyl, an alkenyl, an alkynyl, a cycloalkyl, or an aryl;
wherein two of R¹, R², R³, R⁴, R⁵, and R⁶ are optionally bonded to form a 6-membered aryl;
where:
R¹³, R¹⁴, R¹⁵, R¹⁶, R¹⁷, R¹⁸, R¹⁹, R²⁰, R²¹, and R²² are each independently a hydrogen, an alkyl, an alkenyl, an alkynyl, a cycloalkyl, or an aryl
where:
R²³, R²⁴, R²⁵, R²⁶, R²⁷, R²⁸, R²⁹, R³⁰, R³¹, R³², R³³, and R³⁴ are each independently a hydrogen, an alkyl, an alkenyl, an alkynyl, a cycloalkyl, or an aryl.
